(19) United States
(12) Patent Application Publication
(10) Pub. No.: US 2011/0088565 A1
(43) Pub. Date: Apr. 21, 2011

(54) DEVICE FOR GRILLING FISH

(76) Inventor: Konrad Glas, Possenhofen (DE)

(21) Appl. No.: 12/978,373

(22) Filed: Dec. 23, 2010

Related U.S. Application Data
(63) Continuation of application No. PCT/EP2008/010504, filed on Dec. 11, 2008.

(30) Foreign Application Priority Data
Jul. 15, 2008 (DE) 20 2008 009 506.9

(51) Int. Cl. A47J 37/04

(52) U.S. Cl. 99/421 H

(57) ABSTRACT

A device for grilling fish comprises a cage-type structure, a plurality of holding elements arranged over the length thereof, on which the fish to be grilled is skewered in the longitudinal direction with its belly side open from the bottom, each holding element is designed as a double skewer with two pointed ends at a distance, transversally to the longitudinal direction, between which the rear ridge of the skewered fish is received. Each double-skewer holding element also comprises a transversal section extending beneath the pointed ends of the holding element on which lies the rear ridge of the skewered fish. The device also comprises a plurality of separate transversal skewers which bore above the rear ridge of the fish skewered on the holding elements, transversally to the body of the fish, and can be held in this position in guiding means of the cage-type structure, associated therewith.

### CROSS-REFERNCE TO RELATED APPLICATION

This is a continuation of PCT/EP2008/010504 filed Dec. 11, 2008, which claims priority to DE 20 2008 009 506.9 filed Jul. 15, 2008, the contents of each of which are incorporated herein by reference.

### FIELD OF THE INVENTION

The present invention relates to a new type of device for grilling fish.

### BACKGROUND

Such devices are already known from the state of the art, in various embodiments.

In the simplest case, a simple grilling skewer (for example made of wood or metal) is used for this purpose, onto which the fish to be grilled is skewered in the longitudinal direction, before the skewer and the fish are placed in the vicinity of a suitable heat source of a grilling appliance, for the actual grilling process.

Aside from the fact that the fish to be grilled is already frequently deformed in a disadvantageous manner when the fish is skewered onto the grilling skewer, such a grilling skewer does not always lead to a good grilling result. Placement of the grilling skewer together with the fish in the region of the grilling appliance to be used is also only possible in simple manner if a suitable holder is present on the grilling appliance, or if additional aids, such as those described in DE 203 14 053 U1, for example, are used.

The possible orientations of the fish with regard to the heat source are furthermore restricted if there is no additional ancillary device. Then, the only possibility that exists is to either hold the grilling skewer, which is usually equipped with a handle, in the region of influence of the heat source by hand, or to set it down or lay it down onto a support surface—such as a grill grate situated above a heat source, for example.

In the latter case, the fish comes into direct contact with the grill grate with its outside, and this is disadvantageous. This is because if direct contact occurs between the skin of the fish and the grill grate that is heated during the grilling process (or any other support surface that is present in the region of the heat source), the skin can stick to this and can be damaged over a large area when the fish is turned, for example, or at the end of the grilling process. Damage to the fish skin is not just disadvantageous for esthetic reasons. In particular, fluid that is present in the fish can escape through the damaged skin locations, and as a result, the grilled fish often becomes too dry.

Even after the grilling process, the grilling skewer, together with the fish skewered onto it, can be laid down only onto a hygienically clean surface, for example a plate, since once again, the fish comes into contact with the surface when this is done. If the fish is supposed to be served without the grilling skewer, the grilling skewer, which passed through the fish in the longitudinal direction, must furthermore be removed, and this cannot always be done, or cannot be done in simple manner, without (further) damaging the grilled fish.

Comparable disadvantages are evident from the mackerel grilling skewer that is known from DE 41 27 618 A1.

In order to eliminate the problems mentioned above, other devices for grilling fish have already been proposed. For example, the device for grilling fish that is known from DE 79 35 610 U1 consists of a tray on which a holding device in the form of a crosspiece configured as a blade and standing approximately perpendicular, is configured with a plurality of spikes on its spine, onto which the fish is skewered. Furthermore, a grilling bowl with a raised circumferential edge is known from DE 196 25 467 A1, in which an additional elevation, spaced apart from the edge, is formed as a support for a fish to be set onto it with its belly side, which is open from the bottom.

However, the two devices indicated above are not suitably configured so that the fish can also be exposed to a heat source that acts only from below, for example, in different orientations, as is furthermore the case for the device for grilling fish that is known from DE 92 01 831 U1.

### SUMMARY

Proceeding from the state of the art as explained above, it is the task of the present invention to make available a device for grilling fish, which promises the best possible grilling result, which can be used in the most flexible manner possible, and with which the fish to be grilled can be exposed to a heat source during grilling, in orientations that are as different as possible.

The device for grilling fish, according to the invention, comprises a cage-type structure for laying the device down onto a grilling appliance or onto another essentially planar support surface, where the device has a plurality of holding elements onto which the fish to be grilled can be skewered, in the longitudinal direction, with its belly side, which is open from the bottom.

In this connection, it is provided, according to the invention, that each holding element is configured in the manner of a double skewer, with two pointed ends that are spaced apart perpendicular to the longitudinal direction, between which the spine of the skewered fish is accommodated. Each double-skewer-type holding element furthermore comprises a crosspiece that runs below its pointed ends, on which the spine of the skewered fish rests.

And finally, the device also comprises a plurality of separate transversal skewers that are pushed through the fish skewered onto the holding elements, transversally through its body, above the spine, and can be held in this position in guide means of the cage-type structure, which are assigned to them.

As compared with the previously known devices, a great number of advantages results from this. The holding device implemented in the device according to the invention, which is formed by a plurality of double-skewer-type holding elements having a crosspiece and the (separate) transversal skewers—which interact with suitable guide means on the cage-type structure—ensures secure holding of the fish in the region of its spine, which is particularly stable. In this connection, the spine of the fish is supported on both sides, in the region of the pointed ends of the double-skewer-type holding elements, where the crosspiece of the holding element, which extends upward, ensures lower support of the spine, and represents a kind of stop when the fish is placed on the skewer, so that the fish is also not skewered too far onto the holding elements, in advantageous manner. Furthermore, it can be assured, by means of a suitable configuration of the holding elements, that these hold the belly side of the fish open downward during the grilling process, which improves the grilling result also from the inside of the belly, and can contribute to reducing the time required for grilling.

The transversal skewers, which run transversally through the fish, which is held in the device as intended, secure the fish above its spine, so that the fish is supported, over its length, at a plurality of locations in the region of the spine, from above, from below, from the left and from the right, and therefore is secured all around. The device can therefore be held or positioned in any desired orientation, without the fish falling out of it. The cage-type structure, which preferably frames the fish toward all sides, at a distance, and in which the guide means for the transversal skewers are formed, serves (particularly with its underside) for placing the device onto an essentially plane support surface, such as the grill grate of a commercially available grill, for example.

To the extent that in the present document, a plurality of double-skewer-type holding elements and separate transversal skewers is mentioned, practice has shown that a number of at least two, preferably also three or even four such holding elements and/or transversal skewers is sufficient for adequate securing of the fish within the device.

Since the fish to be grilled is first skewered onto the double-skewer-type holding elements with crosspiece of the device according to the invention, the fish is already sufficiently fixed in place in the region of the spine (particularly toward the side), before the separate transversal skewers are passed through it, so that the transversal skewers can be pushed through the fish in particularly simple and gentle manner, and can easily be removed again after the grilling process, as well.

The guide means that are present on both sides of the cage-type structure, on different sides of the fish (preferably at the same level) preferably serve not only for holding the transversal skewer, in each instance, in its later position, in which it preferably passes through the fish in an essentially horizontal direction, but also advantageously facilitate correct positioning of the transversal skewer relative to them when these skewers are passed through the fish. However, it is the main aspect of the guide means according to the invention to secure a fish that is held in the device, as intended, in the upward direction, in interaction with the transversal skewers, i.e. to prevent the fish from falling out of the device, downward, when the device is turned over. After all, the fish is already secured in all the other directions by means of the holding elements. In the simplest embodiment of the present invention, the guide means could therefore also be referred to as securing means for the transversal skewers. In this connection, however, they can preferably serve as an axial guide for the transversal skewer to be pushed through the fish in its axial direction, in a certain sense, already for the process of pushing them through the fish. However, the latter is not compulsory.

After the fish has been grilled, first the transversal skewers of the device according to the invention are removed, and then the fish can be taken off the holding elements, which can take place by simply turning the device over, for example, so that the fish falls out of the device onto a plate that has been made available, for example.

It is true that the device according to the invention is explicitly designed for holding fish for grilling. Nevertheless, because of its structural characteristics, the device is obviously also suitable for grilling other foods that can be grilled, such as meat, for example (in the form of filets, for example), since this can also be secured within the device, in all directions, in accordance with the above explanations. Furthermore, the device according to the invention is also suitable for other types of preparation of fish, not just for grilling. For example, it can be laid or hung into a steaming pot or cooking pot, together with the fish held in it, for cooking the fish, or can be hung into a deep-frying appliance for deep-frying the fish. Furthermore, the device is also suitable for preparing fish within an oven (cooking, grilling, or oven-roasting), or for smoking the fish in a smoker. With all of the methods of preparation mentioned, an optically more appealing result is frequently achieved, in comparison with preparation of the fish using previously known ancillary devices.

In a first preferred further development of the invention, it is provided that the cage-type structure is configured in such a manner that the device can be laid onto the support surface in different orientations, where the fish contained in it is in contact exclusively with the holding elements and the separate transversal skewers that pass through it, and does not have any contact with the support surface.

In this way, not only is it assured that the fish to be grilled can be grilled from different sides on a commercially available grill, but also that it is in contact exclusively with the holding elements and the transversal skewers that pass through it, in every one of these orientations. The cage-type structure itself, or the elements that serve for laying down the cage-type structure, are therefore preferably spaced apart from the holding elements to such an extent that a fish of usual size, held in the device, does not come into contact with the support elements, and therefore there is no risk of detrimental damage to the fish skin during the grilling process. It is possible to speak of an essentially contact-free grilling process. The punctures of the fish skin caused by the transversal skewers are not of particular importance and can be tolerated within the scope of the present invention.

For fish having a size that deviates greatly from a standard size, a device having corresponding dimensions or a device that is adapted in terms of its dimensions can be provided.

Preferably, care should be taken, by means of suitable configuration of the cage-type structure, to ensure that the different orientations in which the device can be laid down onto the support surface correspond to an orientation of the fish held in the device as intended, in which orientation this fish faces the support surface with its first side flank and/or its second side flank and/or with its belly side and/or with its back. Holding the fish in the back position, i.e. with the back down, proves to be particularly advantageous, since the “juice” of the fish remains in the fish during the grilling or cooking process in this position, and therefore an excellent grilling result can be achieved, in terms of flavor.

The fish to be grilled can therefore be grilled, if the present device is used on the grill grate of a commercially available charcoal, gas, or electric grill, preferably both from below and—one after the other—from both sides and from its top, the side of the dorsal fin. In particular, the possibility of grilling the fish from its top proves to be particularly advantageous, since a large part of the meat of the fish to be grilled is located there.

To hold the fish also in the region of its back end, preferably another holding element is provided, within the scope of another embodiment of the present invention, which is suitably structured for lower and lateral support of the fish held in the device as intended, in the region of its tail fin or in the region of its tail stock. In this connection, one should think of a holding element that is shaped to be concave transversal to the longitudinal direction—viewed from the top—for example, which essentially follows the shape of the tail stock of a fish. Preferably, another separate transversal skewer can then be used in the region of this holding element, by means of suitable guide means on the cage-type structure, to further secure the fish also in the region of its tail fin.

Furthermore, within the scope of the invention, care should preferably also be taken to assure that each double-skewer-type holding element (also) has precisely one separate transversal skewer and related guide means on the cage-type structure assigned to it, where the guide means are structured and disposed in such a manner that the fish held in the device as intended has a transversal skewer passing through it that is assigned to a holding element and held in the guide means, in the immediate vicinity of the holding element assigned to it.

Thus, the guide means for the transversal skewers are preferably placed on the cage-type structure in such a manner that the transversal skewer held by the guide means passes through the fish above the spine and in the immediate vicinity of a double-skewer-type holding element, preferably just above it or just next to its pointed ends. This facilitates not only introduction but also removal of the transversal skewer, because of the immediately adjacent fixation by the holding elements, without the fish that is to be grilled or has been grilled being damaged. Securing of the fish in all possible directions then takes place—in the region of the different holding elements—multiple times over the length of the fish, but always in the immediate vicinity of the holding element disposed there.

The guide means for the separate transversal skewers are preferably formed by an opening that has an edge all around, in which the transversal skewer, in each instance, is axially guided, i.e. particularly held transversal to the axial direction. Of course, in this connection a certain play can or should be present, particularly also in order to be able to meet the requirements of the different dimensions of different fish, within a tolerance range.

Of course, the length of the transversal skewers is preferably adapted to the width of the cage-type structure in the region of the guide means, i.e. to the distance between the guide means that lie opposite one another on different sides, where each transversal skewer preferably projects only a short distance on both sides. It is furthermore advantageous if the transversal skewers have a stop on their end that faces away from the pointed end, so that they are not pushed too far through the fish and can support themselves on the cage-type structure or the guide means with the stop elements.

Other preferred embodiment variants of the invention provide—particularly for volume reduction when they are not in use—that the device is configured so that it can be stacked or that it has a plurality of joints disposed at suitable locations, with which it can be collapsed. It is obvious, however, that it should be ensured—for example by means of a suitable engagement mechanism or a suitable setting element—that the device collapses only when required.

The cage-type structure—just like the holding elements and the separate transversal skewers—is preferably produced from stainless steel, and in particular, the cage-type structure can also be structured in one piece with the holding elements. The same type of stable, heat-resistant and chrome-plated steel wire from which grill grates of the usual type are also made is particularly suitable.

Finally, within the scope of the invention, it is furthermore preferably provided that at least one elongated element projects away from the cage-type structure, on which element a (preferably heat-insulated) handle can be attached or is formed, to grip the device, or an adapter for inserting the device into a turning device is provided. Secure holding of the fish in the device according to the invention particularly also allows its use in an arrangement in which the device is held above a horizontal heat source or in front of a vertical heat source, and rotated about an axis that runs in the longitudinal direction. A handle or another adapter, for example an adapter for suspending the device into a steaming pot or cooling pot for cooking the fish, can also be attached to a transversal crossbar of the cage-type structure (if necessary in releasable manner), in simple manner.

The device according to the invention, for preparing fish, can also be offered for sale as part of a set with a matching steaming pot or cooking pot and/or with—different—adapters/handles, for example.

### BRIEF DESCRIPTION OF THE DRAWINGS

In the following, different exemplary embodiments of the invention are explained in greater detail, using the drawings, in which:

FIG. 1 is a perspective view of an exemplary embodiment of a device according to the invention,

FIG. 2 is a side view of the exemplary embodiment from FIG. 1,

FIG. 3 is a top view of the exemplary embodiment from FIG. 1,

FIG. 4 is a section through the exemplary embodiment from FIG. 1 according to the section plane IV-IV (see FIG. 3),

FIG. 5 is a perspective view of the exemplary embodiment from FIG. 1 with a fish held in it as intended,

FIG. 6 is a perspective view of a second exemplary embodiment of a device according to the invention,

FIG. 7 is a perspective view of a third exemplary embodiment of a device according to the invention,

FIG. 8 is a perspective view of a fourth exemplary embodiment of a device according to the invention.

### DETAILED DESCRIPTION

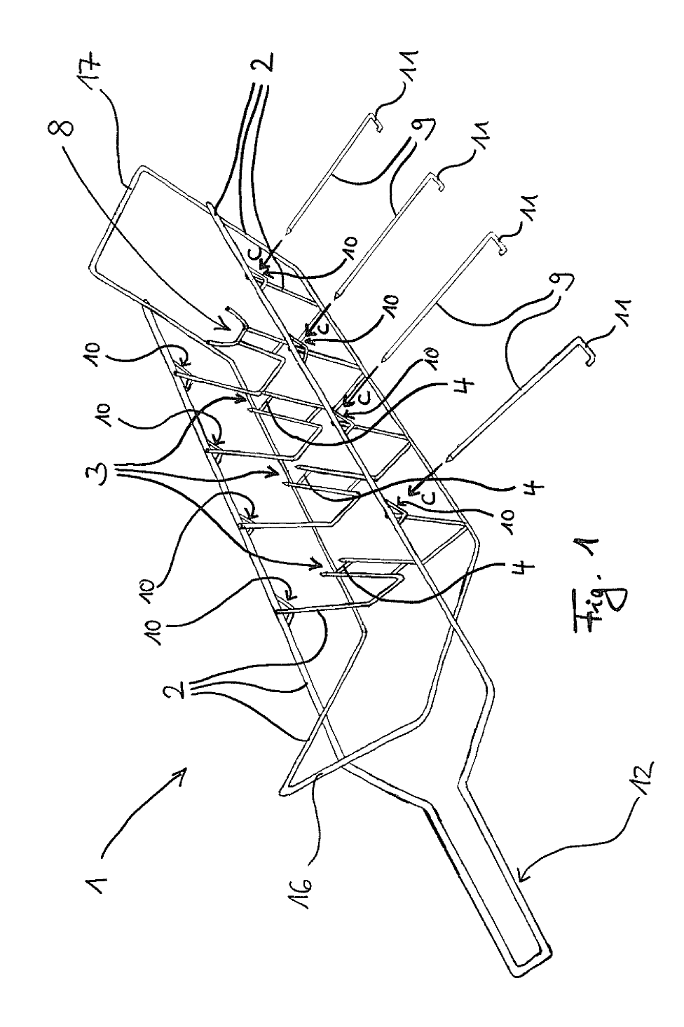

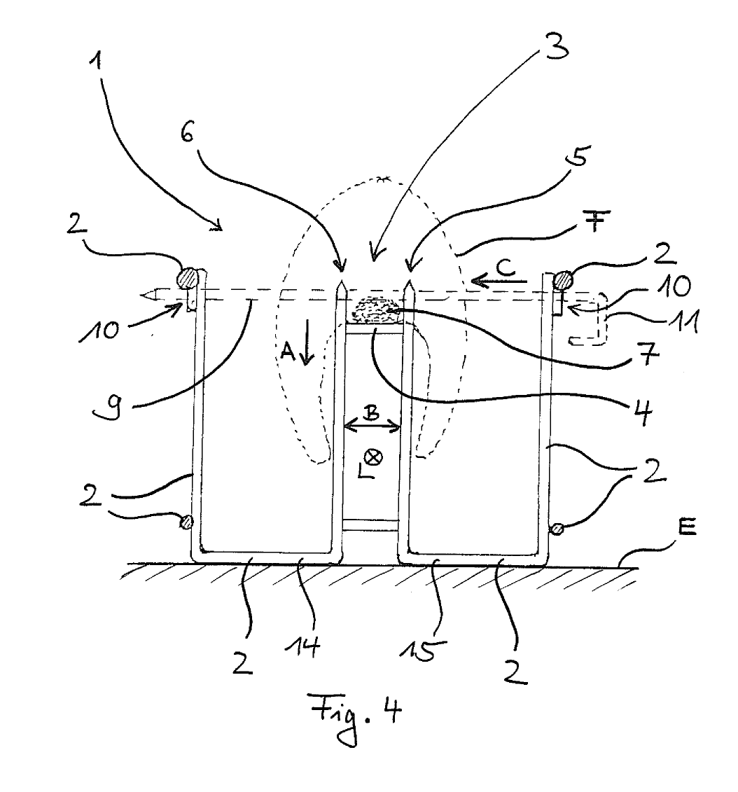

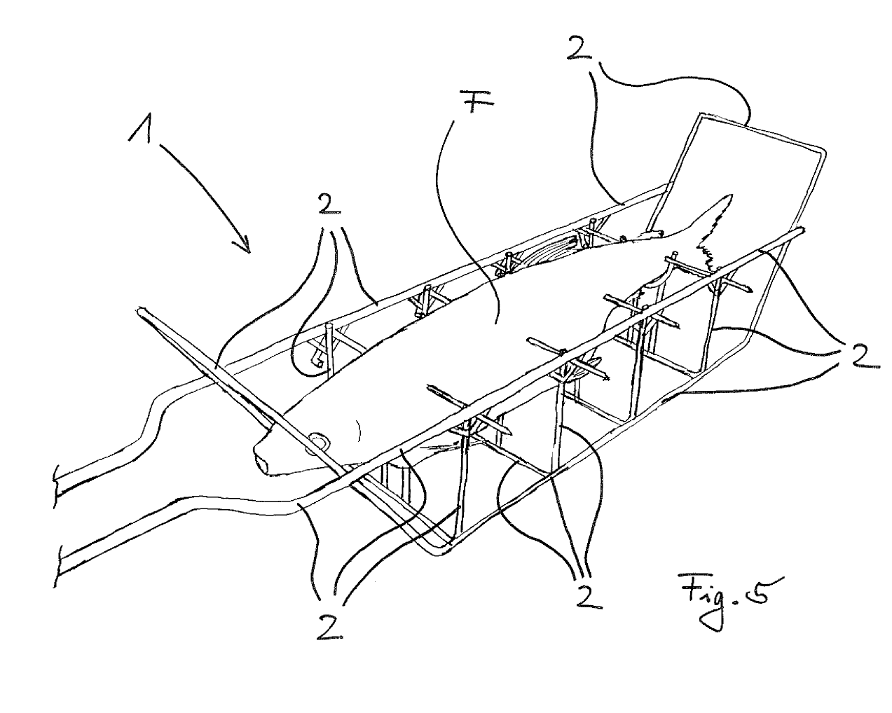

The device 1 shown in FIGS. 1 to 5, for grilling fish, consists of a cage-type structure 2, in which a fish F (see FIG. 4 and FIG. 5) can be accommodated and held in place in the longitudinal direction. For this purpose, a plurality (here: three) of double-skewer-type holding elements 3 are disposed in the device, over its length, the precise structure of which elements will be explained in greater detail below, using the cross-sectional representation.

Each of the double-skewer-type holding elements 3, which extend upward in the orientation of the device 1 as shown here, in which it lies on a plane support surface E with its underside, comprises two pointed ends 5, 6 onto which the fish F (previously cleaned in usual manner) is skewered with its belly side, which is open from the bottom (see FIG. 4) in the direction of the arrow A. The two pointed ends 5, 6 of the holding elements 3 are spaced apart by a distance B perpendicular to the longitudinal direction L of the device 1, so that the spine 7 of the fish F that has been skewered onto the double-skewer-type holding elements 3 from above, according to the arrow A, is accommodated between their pointed ends 5, 6 and thus supported on both sides. Below the pointed ends 5, 6, a crosspiece 4 runs on each holding element 3, on which crosspiece the spine 7 of the fish F rests—when the fish F is skewered on. The two skewers or pointed ends 5, 6 of the holding element 3 are formed, in the present case, by means of shanks of a U-shaped structural element 14, 15 that are adjacent to one another and pointed at the top; their further shanks are part of the cage-type structure 2 that serves for laying the device down.

In FIG. 4, it can furthermore be seen well that the skewers of the holding element 3 that are spaced apart by the distance B in the region of the belly-side opening of the fish being held in the device also hold the fish open on the belly side.

The device 1 furthermore has another holding element 8, which serves as a support for the tail stock of the fish F (situated just in front of the tail fin of a fish).

Furthermore, the device comprises a plurality (here: four) of separate transversal skewers 9, each assigned to precisely one holding element 3, 8, which are pushed through a fish F held in the device 1 as intended, above the spine 7, according to the arrow C, through its body, and are held in this position (see FIG. 4, where the transversal skewer 9 is only shown with a broken line, since it is situated just outside the plane of the drawing), in the guide means 10 assigned to them.

Therefore, two guide means 10 situated at the same height on opposite sides of the cage-type structure 2 interact with each transversal skewer 9, to hold it in its correct position within the device 1. For this purpose, the transversal skewers 9 are first inserted through a first guide means 10—after the fish F has been skewered onto or set onto the holding elements 3, 8. This guide means essentially serves as a positioning aid for the transversal skewer 9. Subsequently, the transversal skewer 9 is pushed through the fish F in the axial direction, according to the arrow C, and with an essentially horizontal orientation, and subsequently introduced into the guide means 10 situated on the opposite side, so that the transversal skewer 9, positioned in this manner, is held within the guide means 10 on both sides of the fish F, and therefore the fish F can no longer be taken out of the device 1 in the upward direction.

The guide means 10 are configured as an opening in the cage-type structure 2 that is edged by a structural element that runs horizontally, in each instance, by a structural element that runs vertically, and by a slanted traverse of the cage-type structure 2, and in this way represent an axial guide with a certain play for a transversal skewer 9. The guide means that only take the vertical direction into consideration, for example in the form of two structural elements that run horizontally and are spaced apart vertically, between which the transversal skewers can be inserted, would also fundamentally be possible as guide means within the scope of the present invention.

A stop 11 at the back end of each transversal skewer 9 prevents the transversal skewer 9 from being pushed through the fish F farther than necessary.

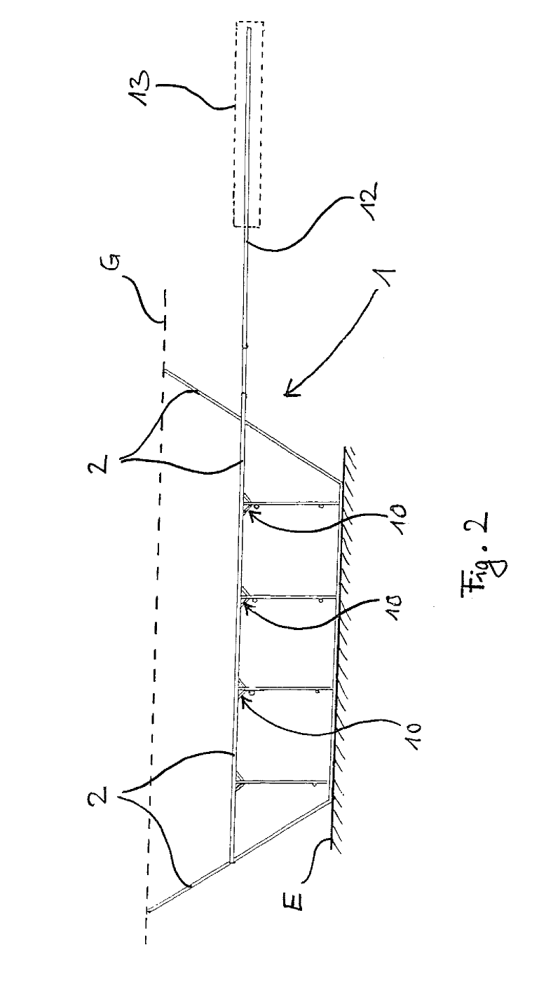

The device 1 that is shown, which is produced in its entirety (including the holding elements 3) from a stainless steel wire, furthermore has an elongated element 12 that projects away from the cage-type structure 2 in the longitudinal direction L, or is formed in one piece with it, which serves as a handle or onto which a separate handle part 13 (for example made of wood or plastic) or an adapter for a turning device can be set, as indicated with broken lines in FIG. 2.

It can furthermore be derived from the side view of FIG. 2 that the cage-type structure 2 is dimensioned and structured in such a manner that the device 1 can be laid down onto the plane surface E not only with its underside, but rather—if one turns it over—it can also be laid down the other way around, as is made clear by the plane G indicated with a broken line. In this orientation, the two uppermost crossbars 16, 17 (see FIG. 1) lie on the support surface G (for example a grill grate).

These two crossbars 16, 17 are offset to the outside, in the longitudinal direction, by means of structural elements of the cage-like structure 2 that run at a slant, on both sides of the device 1, so that the fish F can be set into the device 1 or removed from it again, in the simplest possible manner.

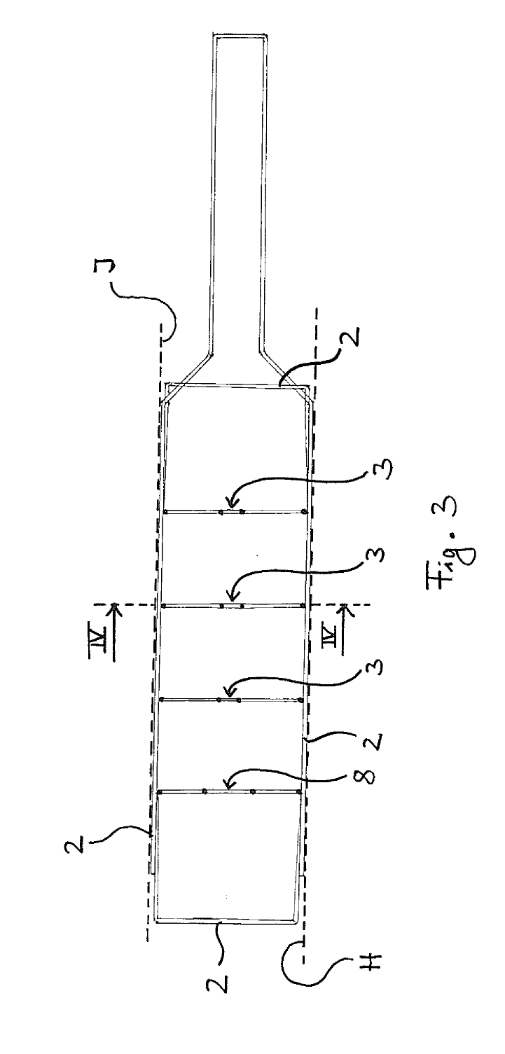

And finally, the top view of FIG. 3 also illustrates, by means of the planes H and I, shown with broken lines, that the exemplary embodiment of a device 1 according to the invention, which is shown, can also be laid down onto an essentially plane substratum H or I (for example the grill grate of a grill) on its side.

Thus, the device 1, together with the fish F firmly held in it in all directions, can be positioned on the grill grate of a grill in four different orientations, so that the fish F can optionally be exposed to the heating effect of the grill with its belly side, its spine side, or one of the side flanks.

FIG. 5 finally also shows how the fish F is held in the device 1 and spaced away from the outer delimitation of the cage-type structure 2 on all sides.

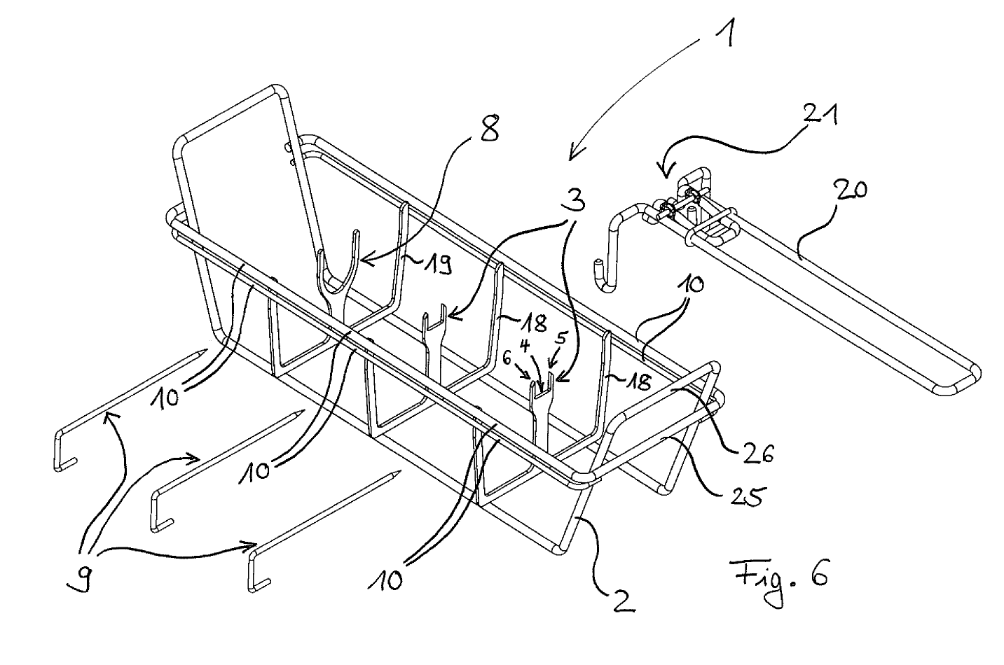

FIG. 6-8 show three additional exemplary embodiments of the present invention; their differences as compared with the first exemplary embodiment will be explained below.

The device 1 from FIG. 6 corresponds to the device according to the first exemplary embodiment already described in many respects. However, in contrast, here only two double-skewer-type holding elements 3 are provided, which are not soldered together from multiple wires, as part of a structural element that reaches all the way to the outside of the cage-type structure 2, but rather are laser-cut from a stainless steel sheet. Thus, the pointed ends 5, 6 that form the double-skewer-type holding element 3 and are spaced apart transversal to the longitudinal direction, together with the crosspiece that lies below them, are cut from a piece of sheet metal, in the manner of a fork-like structure. The same furthermore holds true for the holding element 8 (which supports the tail fin), which is also part of a holding element that is laser-cut from the sheet metal. The guide elements 10 that secure the transversal skewers 9 are formed, in the present case, by two structural elements of the cage-type structure 2 that run horizontally and are spaced apart vertically, through which the transversal skewers 9 can be inserted. Furthermore, the device 1 from FIG. 6 comprises a handle 20 that can be attached to the two transversal traverses 25, 26 of the cage-type structure 2, and fixed in place there, by means of a securing device 21.

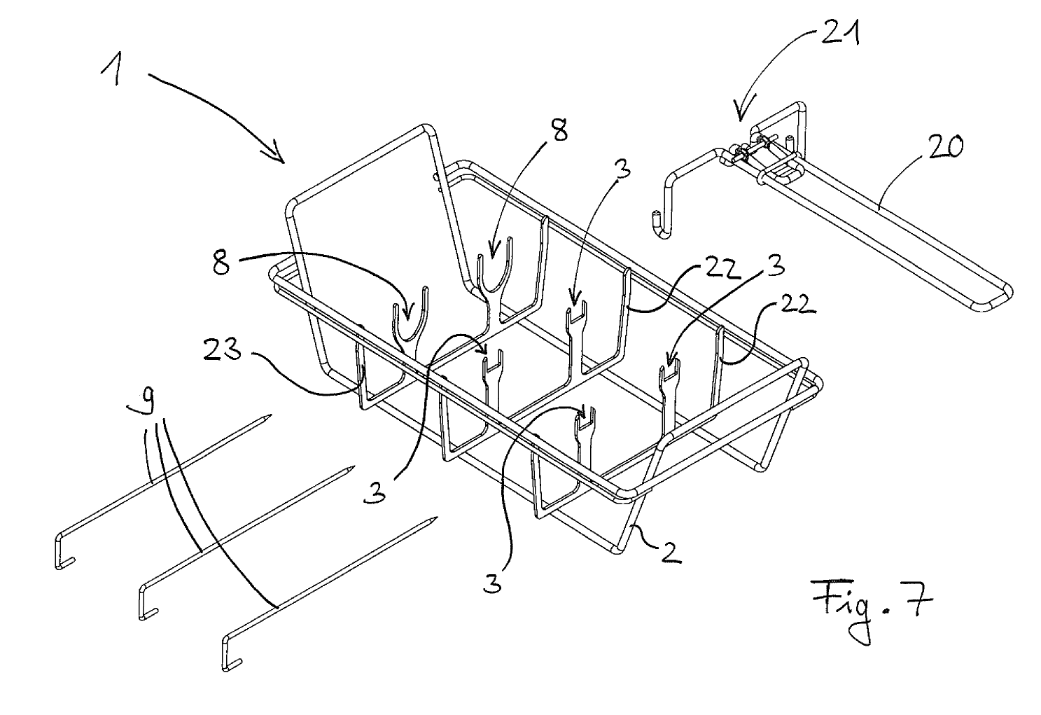

The third exemplary embodiment of a device 1 according to the invention as shown in FIG. 7 differs from the one from FIG. 6, in the final analysis, only in that it is wider and that two fish can be held in it, next to one another, in the sense of the invention. Here, too, the double-skewer-type holding elements 3 are laser-cut out of a stainless steel sheet as part of a larger structure 22, where each of the structures 22 has two holding elements 3 that are disposed next to one another. The same holds true for the holding element 8, two of which are also cut out of a piece of stainless steel sheet 23, next to one another. Furthermore, devices according to the invention in which more than two (for example four) fish are held next to one another, in the sense of the invention, are also possible, where two adjacent fish, in each instance, can also be aligned anti-parallel, if necessary, by means of a suitable configuration of the holding elements.

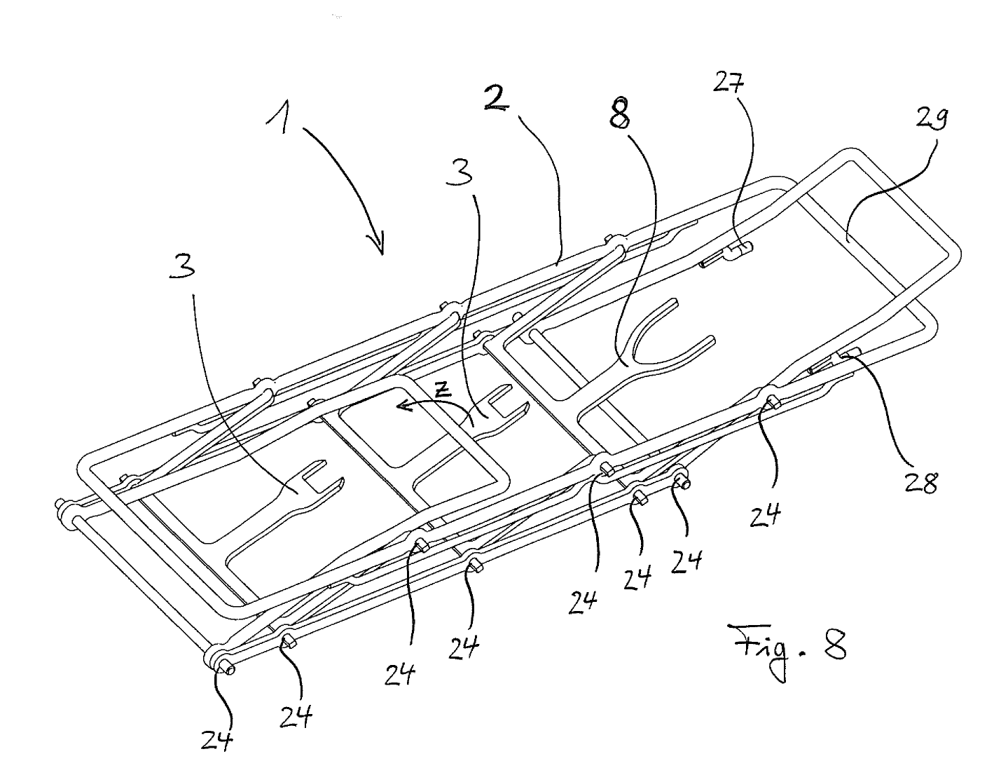

Last but not least, FIG. 8 finally shows a fourth exemplary embodiment of the present invention, which essentially corresponds to the variant from FIG. 6, and was supplemented—on both sides of the device 1—with suitable joints 24, with which the device 1 can be collapsed from a use position into the position shown in FIG. 8, and brought back into a use position from this position—according to the arrow Z. The two stops 27, 28 serve to support the transversal traverse 29 from below in the use position, thereby effectively preventing automatic collapse of the device in the use position.

What is claimed is:

1. Device (1) for grilling fish (F), comprising:
a cage-type structure (2) for placement onto a grilling appliance or an essentially planar support surface (E),
a plurality of holding elements (3) onto which the fish (F) to be grilled can be skewered and held in the longitudinal direction (L), with its belly side, which is open from the bottom,
wherein each holding element (3) of the plurality is configured in the manner of a double skewer having two pointed ends (5, 6) that are spaced apart perpendicular to the longitudinal direction (L), for accommodating a spine (7) of the skewered fish (F), wherein each double-skewer-type holding element furthermore comprises a crosspiece (4) that runs below its pointed ends (5, 6), on which the spine (7) of the skewered fish (F) rests, and
a plurality of separate transversal skewers (9) for pushing through the fish (F) skewered on the holding elements (3) transversally through its body, above the spine (7), the skewers being held in position in guide means (10) of the cage-type structure (2).

2. Device according to claim 1, wherein the cage-type structure (2) is configured in such a manner that the device (1) can be laid down onto a support surface (E, G, H, I), wherein the fish is in contact exclusively with the holding elements (3) and the separate transversal skewers (9) that are pushed through it, and has no contact with the support surface (E, G, H, I).

3. Device according to claim 2, wherein various orientations in which the device (1) can be laid down onto a support surface (E, G, H, I) correspond to an orientation of the fish (F) held in the device (1), in which the fish faces the support surface (E, G, H, I) with its first side flank and/or its second side flank and/or with its belly side and/or with its back.

4. Device according to claim 1, further comprising two, three, or four double-skewer-type holding elements (3).

5. Device according to claim 1, further comprising another holding element (8) suited to support the tail of the fish (F) held in the device (1) at the bottom and the side.

6. Device according to claim 1, wherein each double-skewer-type holding element (3) has precisely one separate transversal skewer (9) and related guide means (10) on the cage-type structure (2) assigned to it, wherein the guide means (10) are structured and disposed in such a manner that the fish (F) held in the device (1) as intended has a transversal skewer (9) passing through it that is assigned to a holding element (3) and held in the guide means (10), in the immediate vicinity of the assigned holding element (3).

7. Device according to claim 1, wherein the guide means (10) for the separate transversal skewers are formed by an opening that has an edge all around, in which the transversal skewer (9), in each instance, is axially guided through the opening.

8. Device according to claim 1, wherein the device (1) is configured so that it can be stacked.

9. Device according to claim 1, wherein the cage-like structure (2) has a plurality of joints that enable the device (1) to be collapsed.

10. Device according to claim 1, further comprising at least one elongated element (12) that projects away from the cage-type structure (2), that defines a handle (13) that is formed from the elongated element or that can be attached thereto for gripping the device, or that defines an adapter for inserting the device into a turning device.
